(19) United States
(12) Patent Application Publication
(10) Pub. No.: US 2018/0193876 A1
(43) Pub. Date: Jul. 12, 2018

(54) METHOD OF FABRICATING A PROTECTED CONSTRUCTION PANEL

(71) Applicant: Trade Fabrication Systems Ltd., Woolston (GB)

(72) Inventor: Howard M. Morris, West Lancashire (GB)

(21) Appl. No.: 15/866,101

(22) Filed: Jan. 9, 2018

(30) Foreign Application Priority Data
Jan. 9, 2017 (GB) 1700339.3

(51) Int. Cl. B05D 1/32; E04F 15/024; B05D 5/10; B32B 7/12

(52) U.S. Cl. CPC B05D 1/325; E04F 15/02405; B05D 5/10; B05D 2350/30; E04F 2201/07; E04F 2290/04; B32B 7/12

(57) ABSTRACT

A method of fabricating a protected construction panel prior to the construction panel being used in construction, the method comprising applying a removable coating onto a surface of the construction panel to form a removable coating layer on said construction panel. A construction panel for use in the construction of a building or the like comprising a removable coating layer located on a surface of said construction panel.

### FIELD OF THE INVENTION

The present invention relates to protected construction panels prior to the construction panels being used in construction and methods of fabricating the same. The methods include applying a removable coating onto a surface of the construction panels to form a removable coating layer on the construction panels.

### BACKGROUND

Construction panels are commonly used to construct flooring and roofing in new buildings. During construction of the new buildings, the flooring is often installed early on in the building process to enable construction workers to walk around the construction site safely. This means that the construction panels are installed, as flooring, before the windows and walls of the building are installed. Similarly, the roofing of new buildings may be installed during the early stages of a construction project to provide coverage of the construction site. In both situations, damage can be caused to the construction panels due to the ingress of rain, wind and general exposure to the surrounding environment. In addition, prior to installing the floor or roof, the construction panels may be stored in the open for a prolonged period during which time they may suffer from weathering damage.

To overcome these issues, it is possible to apply a protective film or layer to a surface (e.g. top/bottom surface) of the construction panels to protect the panels from damage, at least, whilst the construction of the building is ongoing. The application of a protective film or layer to the surface of the construction panel may be performed on a flooring, ceiling, wall or roof constructed from the panels. Whilst the use of conventional protective films/layers does achieve a protective effect, large amounts of adhesive composition are required to adhere the protective film to the surface of the panels. This, generally, involves applying, difficult to handle, hot melt adhesives to both the surface of the panels and the protective film before bonding them together. Once construction of the building is complete, the protective films are then removed and wastefully discarded. The peeling process not only cause traces of adhesive composition to be left on the surface of the flooring, walls or ceiling constructed from the panels, which require additional cleaning, but also generates a large volume of used protective film which requires space on the construction site to be stored before then being discarded.

It is an object of the present invention to obviate or mitigate these problems with the prior art construction panels and protective films.

The present invention seeks to mitigate the above problems by providing construction panels and a method of manufacturing such panels wherein a removable coating is applied onto a surface of the construction panel to form a removable coating layer on said construction panel. The method of the present invention is carried out prior to the construction panels being used in construction

### SUMMARY

In one aspect of the present invention there is provided a method of fabricating a protected construction panel prior to the construction panel being used in construction, the method comprising applying a removable coating onto a surface of the construction panel to form a removable coating layer on said construction panel.

For the purposes of the clarity of the remaining description, the invention may, in parts, be described with reference to construction panels. Such construction panels include, but are not limited to, any panel that is suitable for use in the construction of a building (e.g. a wall, floor or ceiling panel). Such panels are typically rectangular in shape and may be manufactured from any suitable material. For example, a construction panel may be a wooden panel. Where the construction panel is a square, the edges of the panel will be equal in length and its width is defined by a measurement extending orthogonally across a top surface between opposing edges. In some embodiments, the construction panels may be planar or curved. Typically, the construction panels may have a panel width of from about 300 mm to about 1400 mm, panel length of from about 1000 mm to about 5000 mm and a panel height/thickness of from about 3 mm to about 100 mm. More preferably, the construction panels may have a panel width of about 600 mm, panel length of from about 2400 mm and a panel height/thickness of about 22 mm.

In embodiments, the construction panels may include a suitable installation system which allows separate construction panels to be connected to one another in order to form a larger surface, such as a floor, ceiling, wall or roof. For example, the construction panels may include tongue and groove profiled edges to allow for the connecting of separate panels together.

It will be appreciated that the construction panels may be formed of any suitable material. Examples of suitable wood-based materials include, but are not limited to, plywood, oriented strand board (OSB), medium density fibreboard (MDF), timber-board, chipboard, hardboard or any combination thereof.

As used herein, the term “protected construction panel” refers to a construction panel with a removable coating layer which permanently or temporarily provides the surface of the construction panel with a barrier to protect the surface of the construction panel from damage, for example, physical impact, water ingress or UV light exposure.

As used herein, the term “surface” may refer to a top surface and/or bottom surface of a construction panel and may also include the outward facing edges of the construction panel.

In some embodiments, the method of the present invention is performed on a construction panel prior to the construction panel being used in construction. For example, the present method may be performed on separate or individual construction panels prior to the construction panels being used to form a larger surface. This includes the fabricating of protected construction panels before the construction panels are used as part of a floor, ceiling, wall or roof. This provides an advantage over the current methods of protecting construction panel surfaces which, generally, involve applying protective films directly to the floor, ceiling, wall or roof constructed from the panels, since the application of the removable coating can be performed on the construction panels before they reach the construction site, thereby ensuring correct application of the coating and reducing the opportunities for the panel to be damaged (e.g. during transportation to the site of construction).

As described herein, the term “removable coating” refers to any substance which may be applied to the surface of a construction panel to provide the surface with a removable coating layer which provides a protective layer to the surface of the construction panel and may also be removed from the surface without damage to the surface. The removable coating layer may cover the entire surface of the construction panel (i.e. complete coverage) or a part thereof. In some embodiments, the removable coating may be applied to the surface of the construction panel as a sheet-like material. Alternatively, the removable coating may be applied to the surface of the construction panel as a liquid before drying to form the removable coating layer. For example, the removable coating may be applied as a liquid at an elevated temperature before then cooling to provide the removable coating layer. The removable coating layer may be a protective layer formed on the surface of the constructions panel as a film. In further embodiments, the removable coating may be applied to the surface of the construction panel to form a removable coating layer which is peelable. Where the removable coating layer is peelable the user may remove the removable coating layer from the surface of the construction panel manually and without the need for tools or machinery (e.g. film stripping tools or agents). A suitable removable coating may include, but is not limited to, a vinyl acrylate polymer based composition. For example, Protectapeel™ Hotpeel supplied by Spraylat™. In some embodiments, the removable coating may be formed of a material (e.g. Protectapeel™ Hotpeel supplied by Spraylat™) which allows the user to remove (e.g. peel) the removable coating from the surface of the constructions panel before compressing the removed coating/film to reduce its size for ease of disposal. In other embodiments, the removable coating may be formed of a recyclable material.

Preferably, the removable coating is a vinyl acrylate based composition optionally wherein the viscosity of the composition is from about 5000 to about 15000 cPs @ 180° C., from about 8000 to about 12000 cPs @ 180° C., is from about 9000 to about 10000 cPs @ 180° C. or about 8000 cPs @ 180° C.

In embodiments, the step of applying a removable coating onto a surface of the construction panel to form a removable coating layer may be achieved using a variety of application techniques including, but not limited to, brushing/trowelling, spraying, bead-jetting, nozzle dispensing, roller coating, curtain coating, solid application or any combination thereof. As it will be appreciated, suitable application techniques may depend on the type of removable coating being used.

In other embodiments, the step of applying a removable coating onto a surface of the construction panel to form a removable coating layer may be performed using an adhesive composition to adhere the removable coating to the surface of the construction. More preferably, however, the step of applying a removable coating onto a surface of the construction panel to form a removable coating layer may be performed without the need for an adhesive composition to adhere the removable coating to the surface of the construction panel. In such instances, the removable coating may be a self-adhering substance which directly bonds to the surface of the construction panel to form a removable coating layer.

In some embodiments, where the removable coating is a liquid, the step of applying a removable coating onto a surface of the construction panel to form a removable coating layer may be performed at a coat weight of from about 80 to about 160 grams per square metre, from about 80 to about 100 grams per square metre, from about 100 to about 120 grams per square metre, from about 90 to about 130 grams per square metre or from about 120 to about 140 grams per square metre. Preferably, the step of applying a removable coating onto a surface of the construction panel to form a removable coating layer may be performed coat weight of from about 100 to about 140 grams per square metre.

In yet still further embodiments, the step of applying a removable coating onto a surface of the construction panel to form a removable coating layer may be performed at an elevated temperature. Suitable temperatures may depend on the type of removable coating being used and may include, but are not limited to, a temperature of from about 100° C. to about 150° C., from about 50° C. to about 200° C., from about 50° C. to about 150° C., from about 100° C. to about 200° C., from about 120° C. to about 180° C., from about 40° C. to about 160° C. Typically, the temperature of the further adhesive composition may be from about 125° C. to about 175° C. or from about 80° C. to about 150° C. Preferably, the step of applying a removable coating onto a surface of the construction panel to form a removable coating layer may be performed at about 150° C.

In some embodiments, one or more sealant layers may be applied to the surface of the construction panel to form a cured sealant layer on the surface of the construction panel prior to applying the removable coating. Alternatively, the removable coating may be applied to a surface of a construction panel which includes pre-applied sealant layers such as construction panels which are lacquered. In other embodiments, the removable coating may be applied to a surface of a construction panel having a decorative finish, for example pre-painted or stained wood surfaces.

Where there is a step of applying one or more sealant layers to the surface of the construction panel to form a cured sealant layer on the surface of the construction panel prior to applying the removable coating, the cured sealant layer may act to protect a porous surface of the construction panel. This provides a hard and flat surface and allows for the easy application and removal of the removable coating layer as well as easy cleaning of the construction panel surface once the removable coating layer has been removed.

In further embodiments, there may be a step of applying a curable sealant coating onto the surface of the construction panel and curing the curable sealant coating to form a cured sealant layer on the surface of the construction panel prior to applying the removable coating. The cured sealant layer may cover the entire surface of the construction panel (i.e. complete coverage) or a part thereof. In yet further embodiments, the curable sealant coating may undergo a step of curing to form a cured sealant coating. The step of curing may involve, but is not limited to, UV light exposure, elevated temperatures, addition of chemical additives or any combination thereof. A suitable curable sealant coating may include, but is not limited to, an acrylate polymer based composition.

Examples of the curable sealant coating used to form the cured sealant layer on the surface of a construction panel, including the supplier name and grade, are illustrated in the table below.

TABLE 1
Examples of curable sealant coatings

| SUPPLIER | Grade |
|---|---|
| Morrells ™ | 6141-001 |
| Morrells ™ | 6042-001 |
| Morrells ™ | 6441-001 |
| Morrells ™ | U681-0800 |
| Morrells ™ | 6241-001 |
| Morrells ™ | 6341-001 |
| Akzo Nobel ™ | 2795 |
| Akzo Nobel ™ | IN7UE251 |
| Sherwin Williams ™ | ED1240-9001 |

In some embodiments, where the curable sealant coating is UV curable and the step of curing is performed at a wavelength of from about 200 nm to about 500 nm, from about 250 nm to about 450 nm, from about 300 nm to about 400 nm, from about 300 nm to about 350 nm, from about 200 nm to about 400 nm, from about 200 nm to about 300 nm, from about 300 nm to about 500 nm or from about 400 nm to about 500 nm.

In still further embodiments, where the curable sealant coating is UV curable, the step of curing includes a first curing step and a second curing step. For example, the step of curing may include a first curing step performed at a wavelength of from about 200 nm to about 350 nm or from about 220 nm to about 320 nm and a second curing step performed at a wavelength of from about 400 nm to about 450 nm from about 400 nm to about 500 nm. In some embodiments, the step of curing may include a first curing step performed at a wavelength of from about 200 nm to about 350 nm, from about 250 nm to about 350 nm, from about 300 nm to about 350 nm, from about 200 nm to about 300 nm or from about 200 nm to about 250 nm. In other embodiments, the step of curing may include a second curing step performed at a wavelength of from about 450 nm to about 500 nm or from about 400 nm to about 450 nm. It will be appreciated that suitable wavelengths may depend on the type of UV curable sealant coating being used.

In embodiments, the step of applying a curable sealant coating onto the surface of the construction panel may be achieved using a variety of application techniques including, but not limited to, brushing/trowelling, spraying, bead-jetting, nozzle dispensing, roller coating, curtain coating, solid application or any combination thereof. As it will be appreciated, suitable application techniques may depend on the type of curable sealant coating being used. In further embodiments, where the step of applying a curable sealant coating onto the surface of the construction panel is achieved using a roller coating technique, there may be one or more roller coating steps performed in order to achieve a suitable coverage of the curable sealant coating on the surface of the construction panel. For example, the step of applying a curable sealant coating onto the surface of the construction panel may include 1, 2, 3, 4 or 5 roller coating steps performed on the surface of the construction panel.

In some embodiments, there may be step of applying a curable sealant coating onto the surface of the construction panel at a coat weight of about 5 to about 140 grams per square metre, from about 5 to about 100 grams per square metre, from about 10 to about 50 grams per square metre, from about 5 to about 30 grams per square metre, from about 25 to about 80 grams per square metre, from about 50 to about 70 grams per square metre or from about 20 to about 40 grams per square metre. Preferably, there may be step of applying a curable sealant coating onto the surface of the construction panel at a coat weight of from about 10 to about 15 grams per square metre.

In another aspect of the present invention there is provided a construction panel for use in the construction of a building or the like comprising a removable coating layer applied to a surface of the construction panel.

It will be appreciated that the removable coating layer applied to the surface of the construction panel may be formed of any removable coating, as described above, applied to the surface of the construction panel. It is envisaged that the removable coating provides a protective layer on the surface of the construction panel which may be removed from the surface of the construction panel without damaging the surface. In some embodiments, the removable coating layer may be peelable. Where the removable coating layer is peelable the user may remove the removable coating layer from the surface of the construction panel manually and without the need for tools or machinery (e.g. film stripping tools or agents). In some embodiments, the removable coating layer may be formed of a material (e.g. Protectapeel™ Hotpeel supplied by Spraylat™) which allows the user to remove (e.g. peel) the removable coating from the surface of the construction panel before compressing the removed coating/film to reduce its size for ease of disposal. In other embodiments, the removable coating layer may be formed of a recyclable material. The removable coating layer may cover the entire surface of the construction panel (i.e. complete coverage) or a part thereof.

In some embodiments, there is a cured sealant layer applied between the removable coating layer and the surface of the construction panel. The cured sealant layer may cover the entire surface of the construction panel (i.e. complete coverage) or a part thereof. A suitable cured sealant layer may be formed of any suitable curable sealant coating as described herein.

In a further aspect, there is provided a construction panel obtainable by a method of fabricating as described herein.

### BRIEF DESCRIPTION OF THE DRAWINGS

Some embodiments of the present invention are described more fully hereinafter with reference to the accompanying figures. In the figures, dimensions may be exaggerated for clarity of illustration.

FIG. 1 illustrates an exemplary process flow diagram wherein a removable coating is applied to the surface of a construction panel.

FIG. 2 illustrates a UV coating application station and roller used to apply a UV sealant coating to the surface of a construction panel.

FIG. 3 illustrates a UV curing station and lamp used to cure a UV sealant coating applied to the surface of a construction panel.

FIG. 4 illustrates a heater roller coater used to apply a removable coating to the surface of a construction pane.

In the following detailed description, only certain embodiments of the present invention have been shown and described, simply by way of illustration. As those skilled in the art would realise, the described embodiments may preferably be modified in various different ways, all without departing from the spirit or scope of the present invention. Accordingly, the drawings and description are to be regarded as illustrative in nature and not restrictive.

### DETAILED DESCRIPTION

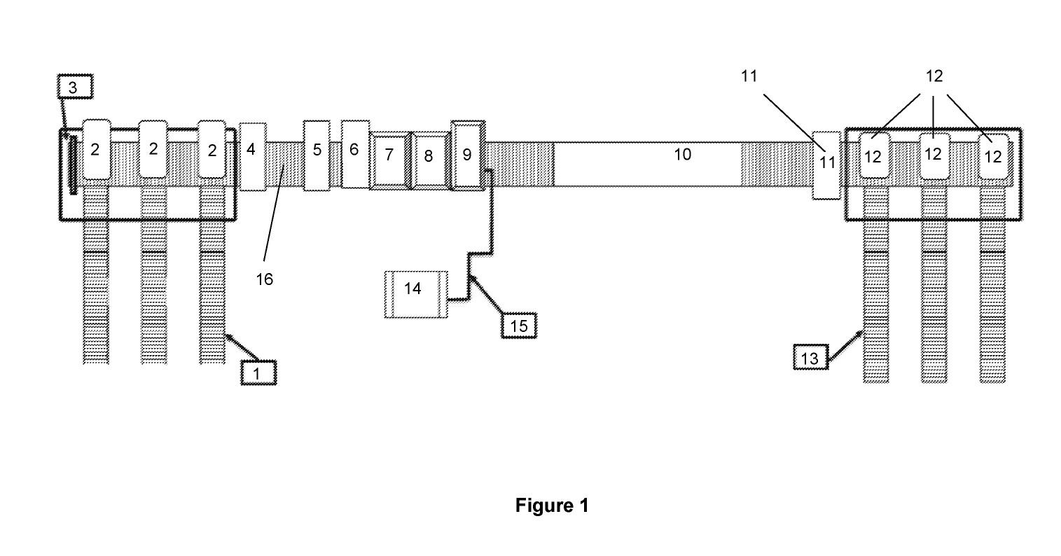

FIG. 1 illustrates an exemplary process flow diagram wherein a protective film is applied to the surface of a construction panel.

Construction panels (not shown) are delivered and loaded on to a feed conveyor system (1). Where the construction panels are delivered in packaging (e.g. bearers, slats, strapping, identification or labels), before being removed, which is done manually. The panels are loaded, using a forklift truck or any other suitable means, onto the feed conveyer system (1) in either single stack or multiple stack arrangements. The feed conveyor system (1) transports the construction panels automatically towards an in-feed vacuum pick-and-place stacking system (2) which in turn transfers the construction panels onto a machine bed (16). Again, the construction panels are loaded on to the machine bed (16), automatically, in either single stack or as multiple stack arrangement.

An in-feed panel pusher (3) then conveys the construction panels along the machine bed (16) and into an in-feed nip roller (4). The construction panels are then conveyed through a brush roller (5) which cleans the surface of the panels. The brush roller (5) is also fitted with an extraction system to remove any dust on the panel surface. The dust is removed and taken away via an extraction pipe.

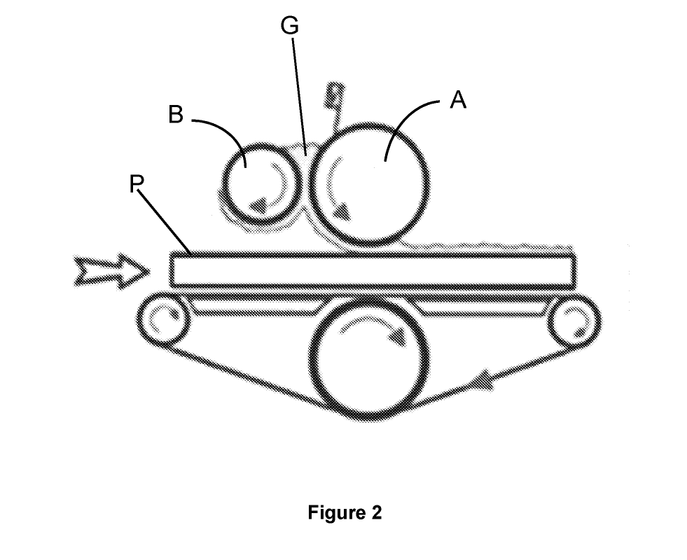

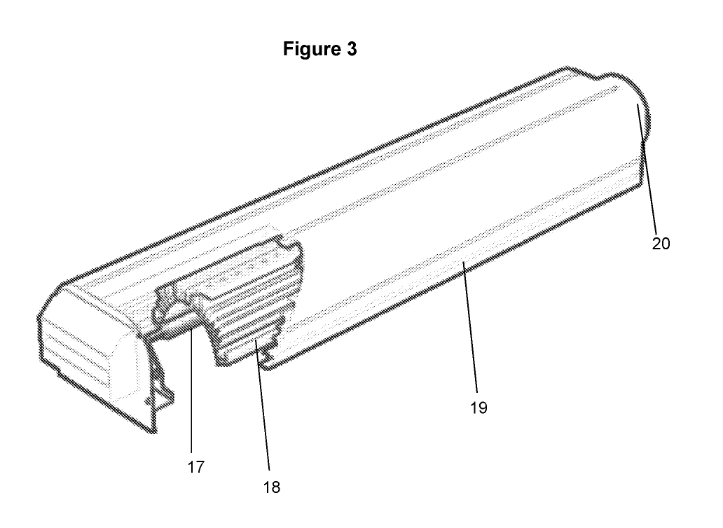

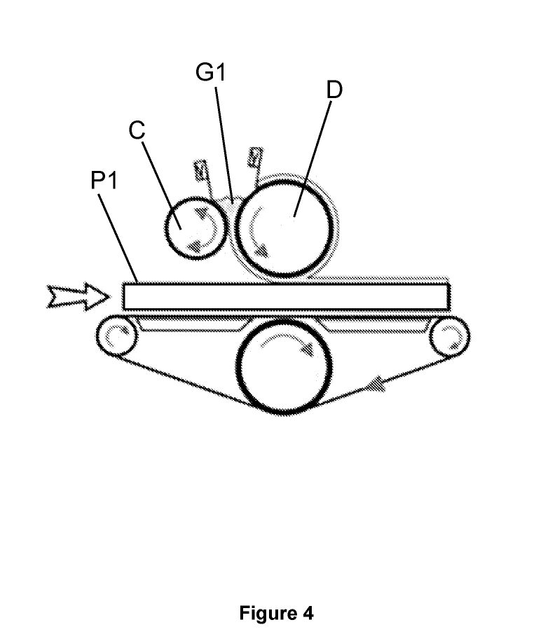

The construction panels are then automatically conveyed from the brush roller (5) into a governor roller (6). The governor roller (6) drives the construction panels along the remainder of the machine bed (16) and controls the line speed. The panels are automatically conveyed from the governor roller (6) into the UV coating application station (7) where a UV coating is applied to the surface of the panels. The UV coating is then cured at UV curing station (8). The application and curing of the UV coating is described in more detail with reference to FIGS. 2 and 3 below. From the UV coating application station, the panels are then fed into the heated coating application station (9) where the removable coating is applied. The removable coating, which may be a peelable coating, is supplied to the heated coating application station (9) via heated hoses (15) from melt tank (14). The application of the removable coating is described in more detail with reference to FIG. 4 below.

The panels are then automatically conveyed from the heated coating application station (9) to an inspection and quality control table (10) where the panels and their coatings are quality checked.

The construction panels are then automatically conveyed from the inspection and quality control table (10) to an outfeed nip roller (11) which directs the construction panels to an outfeed pick and place stacking system (12) where the panels are restacked on to outfeed conveyors (13) in either single stack or multiple stack arrangements.

The stacks are then conveyed from the outfeed conveyor (13) to a packing station, preferably via a forklift truck, where the packs are repackaged into their original/alternative packaging.

FIG. 2 illustrates an example of a UV coating application station (7) as described above. The UV coating application station (7) is made up of an ethylene propylene diene terpolymer (EPDM) coated application roller (A) and a steel dosing roller (B). The two doctor blades are included in the UV coating application station. These doctor blades run along the length of the rollers to prevent the coating flooding the board when run in reverse, they also help with the consistency of the coat weights of the UV coating being applied to the surface of the panels (P). A gap (G) is provided between the steel dosing roller (B) and the EPDM coated application roller (A) which can be adjusted to control the coat weight of the UV coating being applied to the surface of the panels (P). Typical gaps (G) have a measurement of from about 0 to about 3 millimetres depending on the specific requirements of the final construction panel. A heavy coat weight can be achieved by using a larger gap (G) as compared to a lighter coat weight. Typical coat weights that can be achieved by the EPDM coated application roller (A) and steel dosing roller (B) set up range from about 5 to about 100 grams per square metre depending on the type of UV coating being used.

In use, a UV coating is pumped continually into the space between the EPDM coated application roller (A) and the steel dosing roller (B). The UV coating is retained and prevented from spilling from the sides of the rollers by two stainless steel side plates (not shown) situated at each end of the rollers to create a well. Any excess UV coating that flows over the side plates may be recirculated using a pump back to the pump area which applies the UV coating on to the EPDM coating application roller and the steel dosing roller (B).

The EPDM coated application roller (A) rotates in the opposite direction to the steel dosing roller (B) to force the UV coating between the rollers, down the well, through the gap (G) between the rollers and on to the surface of a panel (P) located beneath. The steel dosing roller (B) can be run in either direction to the application roller, however, when run in reverse, lower coating weights are obtainable.

As the machine beds, shown by (16) in FIG. 1, moves the panel (P) along the production line (in the direction of the arrow shown in FIG. 2) the UV coatings applied to the surface of the panel (P) via the EPDM coated application roller (A) at a coat weight corresponding to the gap (G) between the rollers panel (P). As it will be appreciated, UV coatings may be applied to the surface of a panel using one or more UV coating application station. In addition, UV coating application stations suitable for applying a UV coating to the surface of a panel may also include one or more set of application rollers to maximise the coverage of the UV coating on the panel surface and to improve the efficiency of the method. For example, there may be 1, 2, 3, 4 or 5 sets of application rollers for applying UV coating to the surface of the panel.

FIG. 3 illustrates an example of a UV curing lamp used in UV curing station (8) as described above. The UV curing station (8) is made up of three UV curing lamps, the first two UV curing lamps are mercury (H-type) lamps and the third UV curing lamp is a mercury/gallium (V-type) lamp. FIG. 3 shows that a typical UV lamp includes a UV lamp element (17) contained within an outer casing (19). As the UV coated panels move along the machine bed (as shown in FIG. 1) the panels enter the UV curing station and are exposed to the first two mercury lamps having a short UV range of from 220 to 320 nanometres and a spike energy in the longwave range of about 365 nanometres. These lamps are used to cure the UV coatings on the surface of the panels and produce a flat hard surface on which a removable coating (e.g. peelable coating) is applied.

The panels then pass through a third lamp which is a mercury/gallium V-type lamp which yields a strong output in the longwave range of from about 400 to about 450 nanometres. This lamp is used to ensure that the UV coating on the surface of the panels is fully cured. This is especially important where the UV coatings contain heavy pigment or titanium dioxide which may block the shortwave UV exposure provided by the first two mercury lamps. The UV lamp elements may be stored with reflectors (18) to enhance reflection of the UV radiation towards the UV coating on the surface of the panel that is being cured. They UV curing lamps are also fitted with an extraction fan at one end (20) to pull air across the UV lamp element to keep the lamp cool. As it will be appreciated, the UV coatings may be cured using one or more UV curing application station. In addition, UV curing application stations suitable for curing a UV coating on the surface of a panel may also include one or more UV lamps to maximise UV light exposure to the surface of the panel and improve the efficiency of the UV curing step. For example, a suitable UV curing application station may include, but is not limited, 1, 2, 3, 4 or 5 UV lamps each of which may emit UV light at wave length of from 220 to 320 nanometres or of from about 400 to about 450 nanometres.

FIG. 4 illustrates an example of the heated coating application system (9) described above. In particular, the heater roller coater is made up of a silicone coated application roller (D) and a steel dosing roller (C) which are both oil heated by an electric element that goes through the centre of each of the rollers. Each of the rollers may be independently heated at a temperature ranging from about 100° C. to about 150° C. depending on the type of removable coating (e.g. peelable coating) being applied.

A gap (G1) between the rollers (i.e. the distance between the silicone roller (D) and the steel dosing roller (C)) is adjusted to control the coat weight of the removable coating being applied to the surface of the construction panel. Typically gaps having a measurement of about from 0 to about 3 millimetres are used, but, generally, a heavy coat weight can be achieved by using a larger gap as compared to a larger coat weight. Typical coat weights, achieved by the heater roller coater shown in FIG. 4, range from about 80 to about 160 grams per square metre depending on the type of removable coating being applied.

In use, a removable coating is pumped on to the space between the silicone coated application roller (D) and the steel dosing roller (C). The removable coating is retained and prevented from spilling from the sides of the rollers by two pneumatic Teflon™ side plates (not shown) situated at each end of the roller to create a well. The steel dosing roller (C) rotates in the opposite direction to the silicon coated application roller (D) to force the removable coating between the rollers, down the well, through the gap (G1), between the rollers and on to the surface of a panel (P1) located beneath. As the machine bed (16) in FIG. 1, moves the panel (P1) along the production line (in the direction of the arrow shown in FIG. 4) the removable coating is applied to the surface of the panel (P1) by the silicon roller (C) as at a coat weight corresponding to the gap (G1) between the rollers.

It will be appreciated that the methods, materials and equipment/machinery described in relation to FIGS. 1 to 4 above, may be suitably modified by the skilled person to carry out the method of fabricating a protected construction panel prior to the construction panel being used in construction as described herein.

1. A method of fabricating a protected construction panel prior to the construction panel being used in construction, the method comprising:
applying a removable coating onto a surface of the construction panel to form a removable coating layer on said construction panel.

2. A method of fabricating a protected construction panel prior to the construction panel being used in construction according to claim 1, further comprising:
applying a curable sealant coating onto the surface of the construction panel and curing the curable sealant coating to form a cured sealant layer on the surface of the construction panel prior to applying the removable coating.

3. A method of fabricating a protected construction panel prior to the construction panel being used in construction according to claim 2, wherein the curable sealant coating is UV curable and the curing is performed at a wavelength of from about 200 nm to about 500 nm.

4. A method of fabricating a protected construction panel prior to the construction panel being used in construction according to claim 2, wherein the curable sealant coating is UV curable and the curing comprises a first curing step performed at a wavelength of from about 200 nm to about 350 nm and a second curing step performed at a wavelength of from about 400 nm to about 500 nm.

5. A method of fabricating a protected construction panel prior to the construction panel being used in construction according to claim 1, wherein the applying the removable coating onto the surface of the construction panel comprises spraying or roller coating the removable coating onto the surface.

6. A method of fabricating a protected construction panel prior to the construction panel being used in construction according to claim 1, further comprising applying the removable coating onto the surface of the
construction panel at a coat weight of from about 80 to about 160 grams per square metre.

7. A method of fabricating a protected construction panel prior to the construction panel being used in construction according to claim 1, further comprising applying the removable coating onto the surface of the construction panel at a coat weight of from about 100 to about 140 grams per square metre.

8. A method of fabricating a protected construction panel prior to the construction panel being used in construction according to claim 1, further comprising applying the removable coating onto the surface of the construction panel at a temperature of from about 50° C. to about 200° C.

9. A method of fabricating a protected construction panel prior to the construction panel being used in construction according to claim 1, further comprising applying the removable coating onto the surface of the construction panel at a temperature of from about 125° C. to about 150° C.

10. A method of fabricating a protected construction panel prior to the construction panel being used in construction according to claim 1, wherein the removable coating comprises a vinyl acrylate polymer.

11. A method of fabricating a protected construction panel prior to the construction panel being used in construction according to claim 2, wherein the applying the curable sealant coating onto the surface of the construction panel comprises spraying or roller coating the curable sealant coating onto the surface.

12. A method of fabricating a protected construction panel prior to the construction panel being used in construction according to claim 2, further comprising applying the curable sealant coating onto the surface of the construction panel at a coat weight of from about 5 to about 140 grams per square metre.

13. A method of fabricating a protected construction panel prior to the construction panel being used in construction according to claim 2, further comprising applying the curable sealant coating onto the surface of the construction panel at a coat weight of from about 10 to about 15 grams per square metre.

14. A method of fabricating a protected construction panel prior to the construction panel being used in construction according to claim 2, wherein the curable sealant coating comprises an acrylate polymer.

15. A construction panel for use in the construction of a building or the like, the construction panel comprising a removable coating layer applied to a surface of said construction panel.

16. A construction panel for use in the construction of a building or the like according to claim 15, further comprising a cured sealant layer applied between the removable coating layer and the surface of said construction panel.

17. A construction panel for use in the construction of a building or the like according to claim 15, wherein the removable coating layer is a peelable coating layer.
